(19) United States
(12) Patent Application Publication
(10) Pub. No.: US 2021/0195647 A1
(43) Pub. Date: Jun. 24, 2021

(54) COMMUNICATION CONTROL METHOD AND USER EQUIPMENT

(71) Applicants: SHARP KABUSHIKI KAISHA, Sakai City, Osaka (JP); FG Innovation Company Limited, Tuen Mun (HK)

(72) Inventors: CHONGMING CHANG, Shanghai (CN); RENMAO LIU, Shanghai (CN)

(21) Appl. No.: 17/054,497

(22) PCT Filed: May 7, 2019
(86) PCT No.: PCT/CN2019/085833

§ 371 Date: Nov. 10, 2020

(30) Foreign Application Priority Data
May 10, 2018 (CN) 201810445672.1

(51) Int. Cl. H04W 74/08; H04W 74/00; H04W 72/12; H04W 76/11; H04W 80/02; H04L 25/02; H04L 5/00; H04W 28/02

(52) U.S. Cl. CPC H04W 74/0833; H04W 74/004; H04W 72/1268; H04W 72/1257; H04W 28/0278; H04W 80/02; H04L 25/0226; H04L 5/0051; H04W 76/11

(57) ABSTRACT

Provided is a communication control method executed by a user equipment. The method comprises: when a number of times a scheduling request is sent via a Physical Uplink Control Channel (PUCCH) exceeds a specified count, performing a resource configuration process on a resource configuration; generating indication information indicating a content of the resource configuration process; and triggering a random access procedure.

### FIELD

The present disclosure generally relates to wireless communications, and, specifically, to methods related to the corresponding base station and user equipment.

### BACKGROUND

As mobile communication grows and its technology improves, the world is moving into a community that is a completely interconnected network in which anyone may obtain information and share data at anytime and anywhere. It is estimated that there are 50 billion devices that are interconnected in 2020, and among those devices, only 10 billion devices are mobile phones and tablet computers. The rest are devices not communicating between humans but between each another. Therefore, how to design a system that better supports networks connecting all things requires more in-depth study and research.

Studies of the new 5G radio access technology were performed (referring to a non-patent publication: RP-160671 New SID Proposal: Study on New Radio Access Technology) in the #64 plenary meeting for RAN of the 3rd generation partnership program (3GPP) held in March 2016. In proposal, it is disclosed that frequency ranges in the future communication protocol may be expanded to 100 GHz while meeting the requirements of enhanced Mobile Broadband (eMBB), massive Machine-Type Communication (mMTC), and Ultra-Reliable and Low-Latency Communication (URLLC). The work item was ended in 2018.

(1) When the User Equipment (UE) is triggered with a scheduling request, if there is no valid Physical Uplink Control Channel (PUCCH) resource configuration for the scheduling request, the UE initiates a random access procedure and has Message 3 of the random access procedure carry a Buffer Status Report (BSR), so that 5G base station (gNB) knows the UE has data to be transmitted and schedules the transmission accordingly.

(2) If corresponding PUCCH resources are configured for the scheduling request, then the UE sends the scheduling request via a PUCCH and scheduling is implemented without triggering a random access procedure.

(3) When the UE sends multiple scheduling requests via a PUCCH and scheduling is not implemented by the network, the UE notifies a Radio Resource Control (RRC) to release all servicing cell PUCCH resources, notifies an RRC to release all servicing cell Sounding Reference Signaling (SRS) resources, and clears all configured downlink assignments and uplink grants. Subsequently, the UE initiates a random access procedure and has Message 3 of the random access procedure carry a BSR, so that a 5G base station (gNB) knows the UE has data to be transmitted and schedules the transmission accordingly.

Additionally, beam forming technology is introduced in New Radio (NR). When physical link quality appears to be problematic, a beam failure recovery (BFR) procedure may be implemented to recover the link quality. A Random access procedure is also triggered when the UE implements BFR. The random access procedure may solve a competition conflict. In this procedure, the UE may carry a BSR in Message 3.

For the random access procedure that is triggered by a scheduling request, there are two situations that may exist on the UE side.

The first situation is when the UE does not release PUCCH/SRS resources and stores configured downlink assignment and uplink grant (Situation in item (1) above).

The second situation is when the UE releases PUCCH/SRS resources and clears configured downlink assignment and uplink grant (Situation in item (3) above).

On the other hand, a random access procedure triggered by BFR may occur concurrent with PUCCH transmission triggered by a scheduling request. Therefore, if a random access procedure triggered by BFR is successfully completed before the number of times for PUCCH transmission reaches its maximum, then the first situation may occur; otherwise the second situation may occur.

In the second situation disclosed previously, because a resource configuration is released/canceled, the gNB must send reconfiguration information to the UE, reconfigure PUCCH/SRS resources, and reconfigure downlink assignment and uplink grant resources. However, in the present technology, because the gNB cannot identify whether the random access procedure is triggered in the first or the second situation, the gNB cannot specifically configure the reconfiguration information strategy to be sent to the UE. If the gNB sends reconfiguration information to the UE for all the random access procedures to avoid reconfiguration information being missed, then in the first situation, because the UE does not release PUCCH/SRS resources and stores configured downlink assignments and uplink grants, sending reconfiguration information causes unnecessary transmission of reconfiguration information and wastes resource.

### SUMMARY

Based on the previously disclosed issues, the present disclosure provides a communication control method that minimizes unnecessary transmission resource waste cause by reconfiguring information.

According to a first aspect of the present disclosure, there is provided a communication control method executed by user equipment, the control method comprising: when a number of times a scheduling request is sent via a PUCCH exceeds a specific count, performing a resource configuration process on a resource configuration; generating indication information indicating content of the resource configuration process; and triggering a random access procedure.

According to a second aspect of the present disclosure, there is provided a communication control method, comprising: when a number of times a scheduling request is sent via a PUCCH exceeds a specific count, performing a resource configuration process on a resource configuration; and triggering a random access procedure, where

the resource configuration process comprises at least one of:

suspending at least a portion of servicing cell PUCCH resources; and

suspending at least a portion of servicing cell SRS resources; and

suspending at least a portion of configured downlink assignments and uplink grants.

According to a third aspect of the present disclosure, there is provided a communication control method executed by a base station, the method comprising: receiving a random access request and response sent from a user equipment; receiving indication information indicating content of a resource configuration process generated by the user equipment; and controlling reconfiguration of a resource configuration according to the indication information.

According to a fourth aspect of the present disclosure, there is provided a user equipment, comprising: a processor; and a memory storing instructions; wherein, the instructions, when executed by the processor, causes the user equipment to perform a communication control method disclosed previously.

According to a fourth aspect of the present disclosure, there is provided a base station, comprising: a processor; and a memory storing instructions; wherein, the instructions, when executed by the processor, causes the base station to perform a communication control method disclosed previously.

### BRIEF DESCRIPTION OF THE DRAWINGS

FIG. 1 is an illustration chart according to an implementation of the present disclosure.

FIG. 2 is a flow chart of a communication control method carried out by a user equipment according to a first scheme according to an implementation of the present disclosure.

FIG. 3 is a flow chart of a communication control method carried out by a base station according to a first scheme according to an implementation of the present disclosure.

FIG. 4 is a block diagram of a user equipment according to an implementation of the present disclosure.

FIG. 5 is a block diagram of a base station according to an implementation of the present disclosure.

### DESCRIPTION

The following descriptions and accompanying drawings contain detailed descriptions of exemplary implementations of the present disclosure. It should be appreciated that the present disclosure is not limited to the implementations disclosed herein. Additionally, for the ease of understanding, the descriptions do not include detailed descriptions of general knowledge not directly related to the present disclosure in order to avoid confusion of the present disclosure.

Prior to detailed descriptions of the implementations, the following paragraphs defines the terms used in the present disclosure. Unless otherwise specified, the terms in the present disclosure contain the following meanings.

UE User Equipment

NR New Radio

LTE Long Term Evolution

eLTE Enhanced Long Term Evolution

gNB 5G base station

RRC Radio Resource Control

MAC Medium Access Control

CSI PLEASE DEFINE ACRONYM FOR USE

PUCCH Physical Uplink Control Channel

PDCCH Physical Downlink Control Channel

RA Random Access

MAC CE MAC Control Element

MAC PDU MAC Packet Data Unit

RAR Random Access Response

BSR Buffer Status Report

LCD Logical Channel Identify

SRS Sounding Reference Signaling

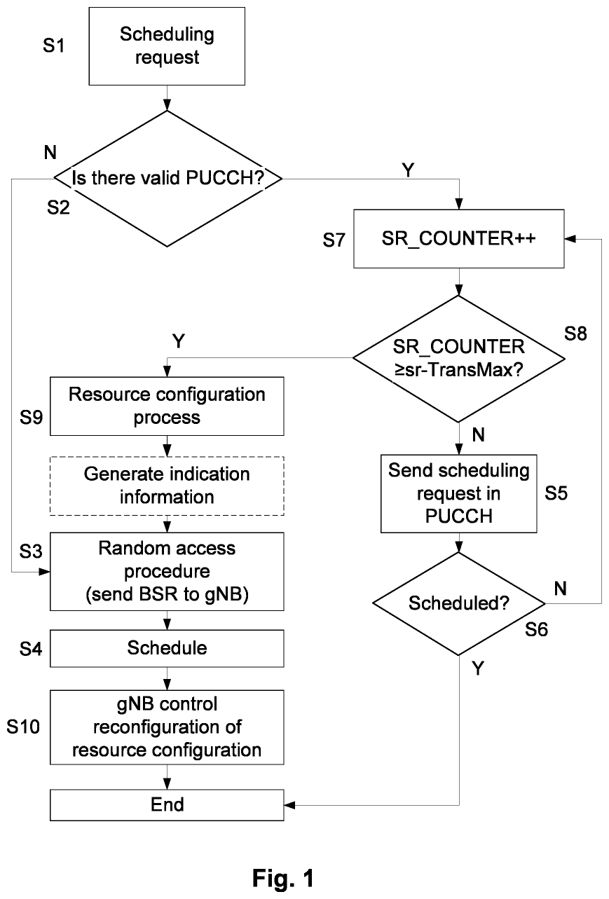

For the ease of understanding, the following paragraphs describes implementations applied in NR mobile communications systems and a progression environment. A base station and UE supporting NR are used as examples to disclose various implementations of the present disclosure. However, it should be noted that the present disclosure is not limited to the following implementations. The present disclosure is suitable for various other radio communications systems, such as an eLTE communications system. The present disclosure is also applicable to other base stations and UE, for example, the base stations and UE supporting eLTE. An example of an aspect of the present disclosure is disclosed with reference to FIG. 1.

FIG. 1 is an illustration chart according to an implementation of the present disclosure. The UE is triggered by a scheduling request or a pending scheduling request (S1). If there is no valid PUCCH resource configuration for the scheduling request (S2: N), the UE activates a random access procedure (RA) (S3). With the random access procedure, the UE sends Message 3 carrying a BSR to a gNB and notifies the gNB with a buffer status report on the UE side, so that the gNB knows the UE has data to be transmitted and schedules the transmission accordingly (S4).

On the other hand, if there are corresponding PUCCH resources configured for the scheduling request (S2: Y), the UE sends a scheduling request via a PUCCH (S5). If the transmission can be scheduled (S6: Y), the transmission is scheduled and completed while no random access procedure is triggered, and the gNB does not reconfigure resource configuration.

The number of times a scheduling request is sent via a PUCCH (S7) is recorded by Counter SR_COUNTER. Prior to the UE sending a scheduling request via a PUCCH, it must be determined (S8) if the value of SR_COUNTER is greater than or equal to a threshold sr-TransMax, wherein sr-TransMax defines the maximum allowable number of times scheduling request may be sent. When SR_COUNTER<sr-TransMax (S8: N), the UE proceeds with instructing the physical layer to send signals for scheduling request in valid PUCCH resources (S5). Subsequently, the UE determines if scheduling is successful (S6). If scheduling is not successful, the increment of counter SR_COUNTER is reversed (S7), and repeat the above determination. When SR_COUNTER>sr-TransMax (S8: Y), the UE performs a resource configuration process to resource configuration (S9). In this example, the resource configuration process may be notifying an RRC to release at least a portion of or all servicing cell PUCCH resources and at least a portion of or all servicing cell SRS resources, and clearing at least a portion of or one of configured downlink assignments and configured uplink grants. Subsequently, the UE activates a random access procedure (S3) and cancels pending scheduling requests. In the random access procedure, the UE sends Message 3 carrying a BSR to the gNB and notifies the gNB with a buffer status report on the UE side so that the gNB knows the UE has data to be transmitted and the gNB schedules transmission accordingly (S4).

The technical concept of a first scheme according to an aspect of the present disclosure is disclosed subsequently. The first scheme is related to after resource reconfiguration process (S9) and before triggering a random access procedure (S3), the UE generates indication information indicating content of the resource configuration process (S9). The UE may thereby determines whether to proceed with reconfiguration and/or with which resource to proceed with reconfiguration according to the indication information (S10) when the base station (gNB) controls the reconfiguration of the resource configuration. This prevents signal waste caused by unnecessary transmission of reconfiguring information.

The technical concept of a second scheme according to an aspect of the present disclosure is disclosed subsequently. The second scheme improves a resource configuration process (S9), suspends, instead of releasing/canceling, at least a portion of the resource configuration and allows the UE to re-activate the suspended resource configuration based on information from the gNB. This minimizes the expenses associated with reconfiguration of resource configuration.

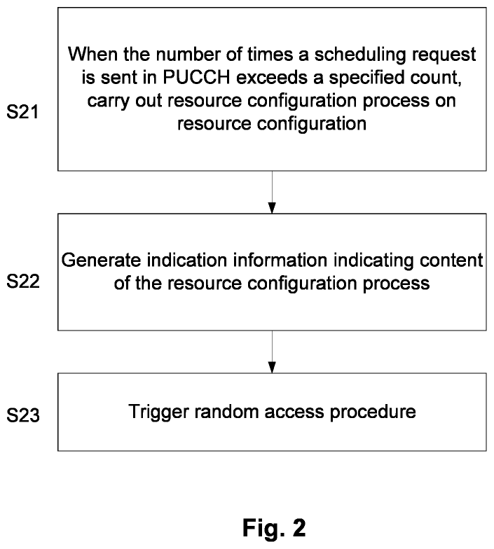

FIG. 2 is a flow chart of a communication control method carried out by a user equipment according to a first scheme according to an implementation of the present disclosure. It should be appreciated that the method of the present disclosure is not limited to the implementation disclosed in FIG. 1. The present disclosure is applicable to any suitable situations/scenarios.

At step S21, when a number of times a scheduling request is sent via a PUCCH exceeds a specific count, the UE performs a resource configuration process on a resource configuration.

At step S22, the UE generates indication information indicating content of the resource configuration process.

At step S23, the UE triggers a random access procedure.

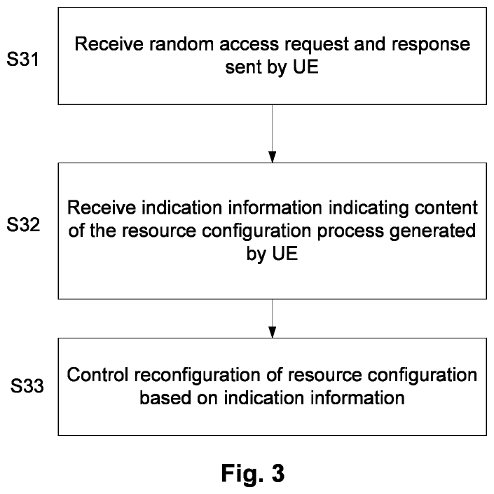

FIG. 3 is a flow chart of a communication control method carried out by a base station according to a first scheme according to an implementation of the present disclosure. It should be appreciated that the method of the present disclosure is not limited to the implementation disclosed in FIG. 1. The present disclosure is applicable to any suitable situations/scenarios.

At action S31, the gNB receives a random access request and response sent by a user equipment.

At action S32, the gNB receives indication information indicating content of the resource configuration process generated by the user equipment.

At action S33, the gNB controls reconfiguration of a resource configuration according to the indication information.

First Scheme

The following discloses the first scheme of the present disclosure in detail in various implementations.

As above, Implementations 1 to 4 further disclose an aspect of the present disclosure that facilitate the gNB to identify whether the UE side is to release resources and, thereby, prevent resource waste caused by unnecessary transmission of reconfiguring information.

Implementation 1

When the pending scheduling request has a corresponding scheduling request configuration,

if SR_COUNTER<sr-TransMax

instructing physical layer to transmit signals for scheduling request in valid PUCCH resource;

otherwise, performing resource configuration process,

releasing all servicing cell PUCCH resources; and/or

releasing all servicing cell SRS resources; and/or

clearing all configured downlink assignments and uplink grants;

for content of indication information indicating resource configuration process, generating MAC CE. Preferably, the MAC CE may carry information, directly or indirectly instructing the UE to release PUCCH resources, to release SRS resources, and/or to clear any configured downlink assignments and uplink grants;

activating/triggering a random access procedure, and canceling all pending scheduling requests.

Preferably, the generation of MAC CE as disclosed previously may be the UE instructing Multiplexing and Assembly procedure or Multiplexing and Assembly Entity to generate MAC CE.

The MAC CE may be represented by a specific LCD value carried in MAC PDU subheader. Its fixed length may be equal to 0 bit or greater than 0 bit.

The MAC CE is used for instructing or notifying the gNB that the UE has released PUCCH resources and/or SRS resources, and/or cleared any configured downlink assignments and uplink grants.

Optionally, this MAC CE may also instruct or notify the gNB that the number of times sent via a PUCCH is no longer less than the maximum allowable number of times. After the gNB receives the instruction, it may be indirectly known that the UE has released PUCCH resources and/or SRS resources, and/or cleared any configured downlink assignments and uplink grants. In this situation, the MAC CE indirectly instructs information to release.

In this implementation, Multiplexing and Assembly procedure or Multiplexing and Assembly Entity means the procedures used for generating MAC CE or MAC PDU, or the procedure responsible for generating MAC CE or MAC PDU entity.

In triggering a random access procedure, the UE sends a preamble, i.e. a random access request, and the gNB receives the request and send a response information to the UE. The UE receives the response information and sends the previously disclosed indication information to the gNB in a scheduled uplink resource. The previously disclosed indication information may be carried in a MAC CE for indicating that the UE has released PUCCH resources and/or SRS resources, and/or cleared any information of configured downlink assignments and uplink grants. The indication information may be for indicating if the number of times the indication information is sent via a PUCCH is greater than a maximum allowable number of times. The gNB reconfigures a resource configuration based on the indication information, sends a PUCCH/SRS resource configuration to the UE, and/or configures a downlink assignment and uplink grant for the UE.

Implementation 2

In Implementation 2, the direct or indirect indication information as previously disclosed may also be carried in a BSR. The detailed implementation is disclosed subsequently.

When an uplink resource is available for transmission, the UE instructs a Multiplexing and Assembly procedure or a Multiplexing and Assembly entity to generate a BSR MAC CE.

If the UE performs the one or more releasing actions as disclosed in Implementation 1, the LCD value of the BSR MAC CE is indicated/represented as a first LCD.

Otherwise, the LCD value of the BSR MAC CE is indicated/represented as a second LCID.

A variation of Implementation 2 is disclosed subsequently.

When an uplink resource is available for transmission, the user equipment instructs a Multiplexing and Assembly procedure or a Multiplexing and Assembly entity to generate a BSR MAC CE.

If the UE does not perform the one or more releasing actions as disclosed in Implementation 1, the LCD value of the BSR MAC CE is indicated/represented as a second LCID.

Otherwise, the LCD value of the BSR MAC CE is indicated/represented as a first LCID.

Another variation of Implementation 2 is disclosed subsequently.

A BSR MAC CE may be represented by a specific LCD value carried in a MAC PDU subheader. When the UE performs one or more releasing actions according to Implementation 1, LCID value is a first LCD; otherwise, LCID value is a second LCD.

A variation of the implementation is disclosed subsequently.

A BSR MAC CE may be represented by a specific LCID value carried in a MAC PDU subheader. When the UE does not perform one or more releasing actions according to Implementation 1, LCID value is a second LCD; otherwise, LCID value is a first LCD.

Implementation 3

Compared to Implementation 2, the UE in Implementation 3 utilizes indirect indication.

When an uplink resource is available for transmission, the user equipment instructs Multiplexing and Assembly procedure to generate a BSR MAC CE.

When the number of times sending a scheduling request via a PUCCH is greater than or equal to the maximum allowable number of times (SR_COUNTER≥sr-TransMax), the LCID value of the BSR MAC CE is indicated/represented as a first LCID.

Otherwise, the LCID value of the BSR MAC CE is indicated/represented as a second LCID.

A variation of Implementation 3 is disclosed subsequently.

When an uplink resource is available for transmission, the user equipment instructs a Multiplexing and Assembly procedure to generate a BSR MAC CE.

If the number of times sending a scheduling request via a PUCCH is less than the maximum allowable number of times (SR_COUNTER<sr-TransMax), the LCID value of the BSR MAC CE is indicated/represented as a second LCD.

Otherwise, the LCID value of the BSR MAC CE is indicated/represented as a first LCID.

Another variation of Implementation 3 is disclosed subsequently.

A BSR MAC CE may be represented by a specific LCID value carried in a MAC PDU subheader. When the number of times sending a scheduling request via a PUCCH is greater than or equal to the maximum allowable number of times (SR_COUNTER≥sr-TransMax), LCID value is a first LCID; otherwise, LCID value is a second LCD.

Yet another variation of Implementation 3 is disclosed subsequently.

A BSR MAC CE may be represented by a specific LCID value carried in a MAC PDU subheader. When the number of times sending a scheduling request via a PUCCH is less than the maximum allowable number of times (SR_COUNTER≥sr-TransMax), LCID value is a second LCID; otherwise, LCID value is a first LCID.

Implementation 4

Compared to Implementation 1, in Implementation 4, the UE only releases/cancels a portion of a resource configuration. In one example, the UE only releases/cancels resources related to current servicing cells.

When a pending scheduling request has a corresponding scheduling request configuration,

if SR_COUNTER<sr-TransMax

instruct a physical layer to transmit signals for scheduling request in valid PUCCH resource;

otherwise,

release current servicing cell PUCCH resources; and/or

release current servicing cell SRS resources; and/or

clear current servicing cell configured downlink assignments and uplink grants;

for content of indication information indicating a resource configuration process, generate a MAC CE. Preferably, the MAC CE may carry information, directly or indirectly instructing the UE to release PUCCH resources, to release SRS resources and/or to clear any configured downlink assignments and uplink grants;

activate/trigger a random access procedure, and cancel all pending scheduling requests.

Preferably, the current servicing cells refer to servicing cells that are currently sending scheduling request signals, or the servicing cells having the PUCCH in which the scheduling requests are sent.

Second Scheme

Moreover, when the gNB cannot clearly distinguish if the UE performs a resource releasing action, in order to avoid or minimize reconfiguration expenses, the gNB may request the UE to not perform resource release, and suspend or instead pause using a resource. Alternatively, the gNB may request the UE to release a portion of the resources, or release a portion of the resources while suspending or pausing the use of other resources. This allows the UE to activate a suspended resource configuration based on information from the gNB, and, thereby, minimize expenses of reconfiguration.

The following descriptions use Implementations 5 and 6 to disclose the first scheme of the present disclosure in detail. This allows the UE to activate the suspended resource based on information from the gNB, and, thereby, avoid expenses of reconfiguration. Furthermore, in the situation when released resource or cleared configuration exist, the gNB may reconfigure the portion of the resource configuration that is released or cleared by the UE, and, thereby, reduce expenses of reconfiguration.

The second scheme is different from the first scheme in that the UE configures, instead of releasing/clearing, at least a portion of the resources by suspending or pausing the resources.

In present NR, there are two types of configured uplink grants: uplink grant configured grant Type 1 and uplink grant configured grant Type 2. The differences between the two types are that the uplink configured grant Type 1 is usable upon configuration, whereas the uplink configured grant Type 2, upon configuration, is usable after the UE receives activation signaling. In the present disclosure, different or the same procedures may be applied to different configured grant types.

Implementation 5

When a pending scheduling request has a corresponding scheduling request configuration,

if SR_COUNTER<sr-TransMax

instruct physical layer to transmit signals for a scheduling request in valid PUCCH resource;

otherwise,

suspend all servicing cell PUCCH resources; and/or

suspend all servicing cell SRS resources; and/or

suspend any configured downlink assignments and uplink grants. Preferably, by suspending uplink configured grant Type 1, releasing a configured downlink assignment and releasing an uplink configured grant Type 2;

initiate/trigger a random access procedure, and cancel all pending scheduling requests.

To resume the previously suspended resources, the following methods may be used.

Method 1: when the triggered random access procedure is successful, the UE may:

resume, initialize or re-initialize the suspended PUCCH resource; resume, initialize or re-initialize the suspended SRS resource.

Method 2: when the UE receives information sent from the gNB that instructs the UE to resume, initialize or re-initialize the suspended PUCCH resource; resume, initialize or re-initialize the suspended SRS resource.

This information may be carried in a MAC CE or in signaling. When the UE receives the information, if the corresponding resource is suspended, the UE then performs resuming, initializing or re-initializing the suspended resource. If the corresponding resource is not suspended or is used in a normal manner, the UE may ignore the information, or perform resuming, initializing or re-initializing the suspended resource.

Suspending PUCCH resources and SRS resources disclosed herein means that the UE stores configuration information of these resources but does not use the resources.

Suspending a configured downlink assignment and uplink grant disclosed herein means that the UE stores configuration information of the configured downlink assignment or uplink grant, but does not use the resources or acknowledge that the resources are activated.

Resuming suspended PUCCH resources and SRS resources disclosed herein means that the UE may use the configured resource in a normal manner prior to the resources being suspended, or configure PUCCH resources or SRS resources according to the stored configuration information.

Resuming, initializing or re-initializing any suspended configured downlink assignment disclosed herein means that the UE configures downlink assignment based on stored configuration information. Preferably, the resumed downlink configuration information are in a non-active state.

Resuming, initializing or re-initializing any suspended configured uplink grant, for configured grant Type 1, disclosed herein means the UE is able to configure resources of configured grant Type 1 in a normal manner as before. For configured grant Type 2, this may refer to resuming configured grant Type 2 that is not yet activated, which is usable when the UE receives activation information.

Implementation 6

Compared to Implementation 5, in Implementation 6, the UE may release a portion of the resources, or suspend a portion of the resources, and release a portion of the resources while suspending a portion of the resources.

When a pending scheduling request has a corresponding scheduling request configuration,

if SR_COUNTER<sr-TransMax

instruct a physical layer to transmit signals for a scheduling request on a valid PUCCH resource;

otherwise,

release current servicing cell PUCCH resources; and/or

suspend other servicing cell PUCCH resources; and/or

release current servicing cell SRS resources; and/or

suspend other servicing cell SRS resources; and/or

clear current servicing cell configured downlink assignments and uplink grants; and/or

suspend other servicing cell configured downlink assignments and uplink grants; and/or

activate/trigger a random access procedure, and cancel all pending scheduling requests.

Preferably, the current servicing cells refer to servicing cells that are currently sending scheduling request signals, or the servicing cells having the PUCCH in which the scheduling requests are sent. Other servicing cells mean servicing cells excluding current servicing cells.

To resume the previously disclosed suspended resources, the method of Implementation 5 may be used.

The following descriptions explain releasing resources with Implementation 7.

Implementation 7

Based on the methods disclosed previously, releasing resources may refer to a MAC layer notifying or requesting a higher layer of the UE, such as an RRC, to release a PUCCH resource configuration. When the higher layer of the UE receives the notification or request from a lower layer to release a PUCCH resource, the UE releases a PUCCH related configuration included in corresponding configuration information.

The UE may notify a higher layer to release all servicing cell PUCCH resources. The UE may also notify a higher layer to release all current servicing cell PUCCH resources. Furthermore, the UE may also notify a higher layer to release servicing cell grants and PUCCH resources related to scheduling requests.

Correspondingly, when the UE receives a request to release PUCCH resources from a lower layer, the UE may release a configuration related to PUCCH included in the corresponding configuration information. For example, a PUCCH resource configuration used for CSI is included in configuration reported by CSI, PUCCH resource configuration is also included in configuration of scheduling request. The UE may then release the PUCCH resources in a CSI report configuration and scheduling request configuration, which refers to releasing all configurations related to the PUCCH.

Additionally, when the UE receives a request related to PUCCH resources from a lower layer, the UE releases PUCCH resources included in a scheduling request configuration, and does not release PUCCH resources included in a CSI report configuration, which may be referred to as partially releasing configuration related to PUCCH.

The UE may instruct to release all PUCCH configurations or to release a portion of a PUCCH configuration in an instruction to a higher layer and, based on a lower layer instruction, the UE performs corresponding release actions. In one example, when the UE notifies a higher layer to release servicing cell grants and scheduling requests related PUCCH resources, the UE only releases the PUCCH resources included in a scheduling request configuration.

The MAC layer may also notify or request a higher layer of the UE, such as an RRC, to release an SRS resource configuration.

When a higher layer of the UE receives notifications or requests related to releasing an SRS from a lower layer, the UE releases configurations related to SRS included in corresponding information. Correspondingly, when the UE receives requests related to releasing SRS resources from a lower year, the UE may release SRS resource configurations included in SRS related configuration information.

In addition, when the UE releases current servicing cell PUCCH/SRS resources, the UE may provide information related to current servicing cells when instructing a higher layer to release PUCCH/SRS resources. The information may be cell identification or cell code. The UE may also instruct a higher layer about which cell PUCCH/SRS resources are to be released when instructing the higher layer to release PUCCH/SRS resources.

Additionally, the UE may trigger a random access procedure when performing a Beam failure recovery (BFR) procedure. This random access procedure may solve a time-based competition conflict. In this procedure, the UE may include a BSR in Message 3. In the random access procedure triggered by BFR, when the gNB receives Message 3 that carries a BSR, the gNB may recognize this as a random access triggered by a scheduling request. This may result in identifying being more difficult, and lead to unnecessary expenses of reconfiguration information. Implementation 8 addresses the issues related to a random access procedure triggered by BFR.

Implementation 8

For a random access procedure triggered by beam failure recovery, Message 3 does not carry a BSR. This scheme eliminates field interference caused by BFI. The detailed implementation of the method is disclosed subsequently.

When the UE successfully receives a random access response in a random access procedure is triggered by beam failure recovery or a beam related event, the UE instructs a Multiplexing and Assembly procedure or Multiplexing and Assembly Entity to not include a BSR in an uplink transmission.

Another implementation of this method is disclosed subsequently.

When the UE successfully receives a random access response in a random access procedure not triggered by beam failure recovery or a beam related event, the UE instructs a Multiplexing and Assembly procedure or Multiplexing and Assembly Entity that a BSR may be included in an uplink transmission.

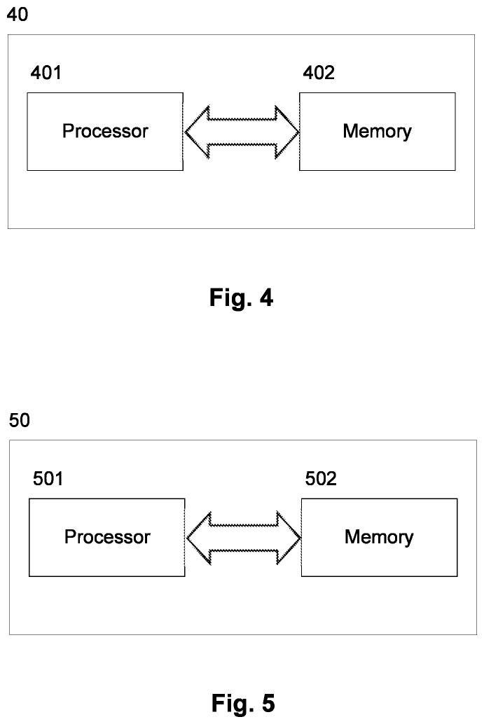

FIG. 4 is a block diagram of a user equipment 400 according to an implementation of the present disclosure. As shown in FIG. 4, the user equipment 400 comprises a processor 401 and memory 402. The processor 401, in one example, may comprise a microprocessor, a microcontroller, an embedded processor, etc. The memory 402, in one example, may comprise volatile memory (e.g., random access memory RAM), a hard disk drive (HDD), non-volatile memory (e.g., flash memory), or any other memories. The memory 402 stores program instructions. The program instructions, when executed by the processor 401, cause the user equipment to perform the communication control methods disclosed herein.

FIG. 5 is a block diagram of a base station 500 according to an implementation of the present disclosure. As shown in FIG. 5, the base station 500 comprises a processor 501 and memory 502. The processor 501, in one example, may comprise a microprocessor, a microcontroller, an embedded processor, etc. The memory 502, in one example, may comprise volatile memory (e.g., random access memory RAM), a hard disk drive (HDD), non-volatile memory (e.g., flash memory), or any other memories. The memory 502 stores program instructions. The program instructions, when executed by the processor 501, cause the base station to perform the communication control methods disclosed herein.

According to the present disclosure, executing programs stored on a user equipment or base station may be implemented by a controlling Central Processor Unit (CPU) and causing a computer to process the program functions of the present disclosure. The programs or information processed by the program may be stored in volatile memory (e.g., random access memory (RAM)), a hard disk drive (HDD), non-volatile memory (e.g., flash memory), or any other suitable memory system.

The programs that perform the functions of each implementation in the present disclosure may be stored on a computer-readable medium. Computer systems, by processing the programs stored in the storage medium, execute the programs to perform the corresponding functions. The “computer system” disclosed herein may be a computer system embedded in a user equipment or base station and may include an operating system or hardware (e.g., peripheral equipment). A “computer-readable medium” may be a semiconductor storage medium, optical storage medium, a magnetic storage medium, a storage medium for short-term dynamic storing of programs, or any other storage medium readable by a computer.

Various characteristics or function modules disclosed in the above implementations herein may be realized or implemented by electronics such as a monolithic or multiple-chip integrated circuit. The electronics designed for implementing the functions disclosed herein may include general processors, a digital signal processor (DSP), Applications Specific Integrated Circuitry (ASIC), Field Programmable Gate Arrays (FPGAs) or any other programmable logic devices, discrete gate or transistor logic, discrete hardware assembly, or any combination of the disclosed devices. A general processor may be a microprocessor, or any present processor, controller, microcontroller, or state machine. The disclosed electronics may be digital electronics or analog electronics. As semiconductor technology continues to improve, it is noted that there may be new integrated circuit technology replacing present integrated circuits and one or more implementations of the present disclosure may be implemented with the new integrated circuit technology.

Moreover, the present disclosure is not limited to the disclosed implementations. Although various examples are disclosed in each implementation, it should be noted that the present disclosure is not limited to thereto. Fixed or non-mobile electronic equipment installed indoor or outdoor may be in a form of terminal equipment or communications. For example, the electronic equipment may be Audio-Video equipment, kitchen equipment, cleaning equipment, air-conditioner equipment, office equipment, vending machines, and other home appliances etc.

The implementations of the present disclosure are disclosed in detail with reference to the accompanying drawings. However, the implementations are not limited to the disclosed implementations. The present disclosure also includes design variations without departing from the scope or spirit of the disclosed concepts. Furthermore, the present disclosure also encompasses modifications within the scope of the claims, implementations suitably combining various disclosed implementations. Additionally, the disclosed implementations may have component substitutions that have similar effect.

1. A communication control method executed by user equipment, the control method comprising:
when a number of times a scheduling request is sent via a Physical Uplink Control Channel (PUCCH) exceeds a specific count, performing a resource configuration process on a resource configuration;
generating indication information indicating content of the resource configuration process; and
triggering a random access procedure.

2. The communication control method according to claim 1, wherein:
the indication information is a Medium Access Control (MAC) Control Element (CE) generated while instructing a multiplexing and assembly procedure or is generated by multiplexing and assembly entity; and
the resource configuration process comprises at least one of:
releasing at least a portion of servicing cell PUCCH resources; and
releasing at least a portion of servicing cell Sounding Reference Signaling (SRS) resources; and
clearing at least a portion of downlink assignments and uplink grants.

3. The communication control method according to claim 1, further comprising:
releasing current servicing cell PUCCH resources, and suspending other servicing cell PUCCH resources;
releasing current servicing cell Sounding Reference Signaling (SRS) resources, and suspending other servicing cell SRS resources; and
clearing current servicing cell configured downlink assignments and uplink grants, and suspending other servicing cell configured downlink assignments and uplink grants.

4. The communication control method according to claim 2,
wherein:
in the MAC CE, a MAC Packet Data Unit (PDU) subheader carries a specific Logical Channel Identify (LCID) value representing content of the resource configuration process; and
a fixed length of the MAC PDU subheader is greater than or equal to 0 bits.

5. The communication control method according to claim 2, further comprising at least:
when an uplink resource is available for transmission, generating a Buffer Status Report (BSR) MAC CE by instructing a Multiplexing and Assembly procedure or a Multiplexing and Assembly Entity; and
if the performs resource configuration process is performed, indicating a Logical Channel Identify (LCID) value of the BSR MAC CE as a first LCID; and
if the resource configuration process is not performed, indicating the LCID value of the BSR MAC CE as a second LCID; and
if a number of times a scheduling request is sent via PUCCH exceeds the specific count, indicating the LCID value of the BSR MAC CE as the first LCID; and
if the number of times the scheduling request is sent via PUCCH does not exceed the specific count, indicating the LCID value of the BSR MAC CE as the second LCID.

6. A communication control method, comprising:
when a number of times a scheduling request is sent via a Physical Uplink Control Channel (PUCCH) exceeds a specific count, performing a resource configuration process on a resource configuration; and
triggering a random access procedure,
wherein the resource configuration process comprises at least one of:
suspending at least a portion of servicing cell Physical Uplink Control Channel (PUCCH) resources; and
suspending at least a portion of servicing cell Sounding Reference Signaling (SRS) resources; and
suspending at least a portion of configured downlink assignments and uplink grants.

7. The communication control method according to claim 3, further comprising:
suspending an uplink configured grant Type 1; and
clearing a downlink assignment and an uplink configured grant Type 2, wherein:
the uplink configured grant Type 1 is usable upon configuration;
the uplink configured grant Type 2, upon configuration, is usable after receiving an activation signal.

8. The communication control method according to claim 3, further comprising:
when the triggered random access procedure is successful, resuming, initializing or re-initializing the suspended servicing cell PUCCH resources and suspended servicing cell SRS resources; or
resuming, initializing or re-initializing the servicing cell PUCCH resources and suspended servicing cell SRS resources according to information received from a 5G base station (gNB).

9. A communication control method executed by a base station, the method comprising:
receiving a random access request and response sent from a user equipment;
receiving indication information indicating content of a resource configuration process generated by the user equipment; and
controlling reconfiguration of a resource configuration according to the indication information.

10. A user equipment, comprising:
a processor; and
a memory storing instructions;
wherein, the instructions, when executed by the processor, causes the user equipment to perform a communication control method according to claim 1.

11. The communication control method according to claim 6, further comprising:
suspending an uplink configured grant Type 1; and
clearing a downlink assignment and an uplink configured grant Type 2, wherein:
the uplink configured grant Type 1 is usable upon configuration;
the uplink configured grant Type 2, upon configuration, is usable after receiving an activation signal.

12. The communication control method according to claim 6, further comprising:
when the triggered random access procedure is successful, resuming, initializing or re-initializing the suspended servicing cell PUCCH resources and suspended servicing cell SRS resources; or
resuming, initializing or re-initializing the servicing cell PUCCH resources and suspended servicing cell SRS resources according to information received from a 5G base station (gNB).

13. A user equipment, comprising:
a processor; and
a memory storing instructions;
wherein, the instructions, when executed by the processor, causes the user equipment to perform a communication control method according to claim 2.

14. A user equipment, comprising:
a processor; and
a memory storing instructions;
wherein, the instructions, when executed by the processor, causes the user equipment to perform a communication control method according to claim 3.

15. A user equipment, comprising:
a processor; and
a memory storing instructions;
wherein, the instructions, when executed by the processor, causes the user equipment to perform a communication control method according to claim 4.

16. A user equipment, comprising:
a processor; and
a memory storing instructions;
wherein, the instructions, when executed by the processor, causes the user equipment to perform a communication control method according to claim 5.

17. A user equipment, comprising:
a processor; and
a memory storing instructions;
wherein, the instructions, when executed by the processor, causes the user equipment to perform a communication control method according to claim 6.

18. A user equipment, comprising:
a processor; and
a memory storing instructions;
wherein, the instructions, when executed by the processor, causes the user equipment to perform a communication control method according to claim 7.

19. A user equipment, comprising:
a processor; and
a memory storing instructions;
wherein, the instructions, when executed by the processor, causes the user equipment to perform a communication control method according to claim 8.
